(19) United States
(12) Patent Application Publication
(10) Pub. No.: US 2007/0126405 A1
(43) Pub. Date: Jun. 7, 2007

(54) Battery charging system and related method for preventing overheating while charging

(76) Inventors: Wei-Peng Kao, Kao-Hsiung City (TW); Chih-Chang Chen, Tainan Hsien (TW); Tsung-Ju Tsai, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/164,703

(22) Filed: Dec. 2, 2005

(51) Int. Cl. H02J 7/04

(52) U.S. Cl. 320/150

(57) ABSTRACT

A battery charging system charges a battery using a charging circuit. The battery has an input port for receiving a charging current and a thermistor electrically connected to an output port. For battery temperatures above a threshold temperature, a resistance produced by the thermistor increases as the battery temperature increases. The charging circuit includes an input connector electrically connected to the output port of the battery and a resistance measuring circuit for measuring the resistance produced by the thermistor of the battery. A current generating circuit produces a charging current according to the measured resistance, and as the measured resistance increases, the charging current produced by the current generating circuit decreases. An output connector of the charging circuit is electrically connected to the input port of the battery for providing the charging current to the battery.

### BACKGROUND OF THE INVENTION

1. Field of the Invention

The present invention relates to a battery charging system, and more specifically, to a battery charging system that decreases a charging current provided to a battery when the temperature of the battery increases for preventing damage to the battery.

2. Description of the Prior Art

With the increase in popularity of portable electronics devices, many devices are now powered by rechargeable batteries. Due to the large amount of electric current needed to fully charge batteries, the batteries can become very hot while charging. However, if the batteries become too hot, the batteries may experience thermal runaway, can become damaged, or may even explode.

For devices such as mobile phones, software can be used to control the charging process when charging the mobile phone's battery. However, due to the potential dangers involved with battery charging, and due to the fact that software is prone to errors, many mobile phone manufacturers prefer to instead use a battery charger to charge mobile phone batteries.

Please refer to FIG. 1. FIG. 1 is a diagram of a battery charging system 10 according to the prior art. The battery charging system comprises a charging circuit 20 used for charging a battery 30. The battery 30 contains a positive voltage terminal 32 for receiving a charging current Ic from the charging circuit 20, and a negative voltage terminal 36 connected to ground. In addition, the battery 30 also contains a negative temperature coefficient (NTC) thermistor 38 connected between the negative voltage terminal 36 and a resistance outputting port 34. The NTC thermistor 38 produces an electrical resistance according to the temperature of the battery 30. Since the NTC thermistor 38 has a negative slope, the resistance produced by the NTC thermistor 38 decreases as the temperature of the battery 30 increases. This relationship between the temperature of the battery 30 and the resistance output by the NTC thermistor 38 in the form of voltage will be first converted to digital form through an analog-to-digital converter 40, then the voltage inputs into the controller 50, which has a mapping table of digital signal versus temperature. A temperature threshold value is also recorded in the controller 50 to compare if the mapping results from the mapping table are in under this threshold value. If the mapping results are under threshold value, then the controller 50 outputs a digital bit indicative of normal charging status to general purpose input/output (GPIO) port 51 (e.g. a bit with a value of “1”), so that the charging current Ic will continue to be supplied to the battery 30; if the mapping results are above the threshold value, then the controller 50 outputs a digital bit indicative of abnormal charging status to GPIO port 51, so that the charging current Ic will be cut off, and will no longer be supplied to the battery 30. More specifically, since the charging current Ic is decided by the resistance R serial to the pin PROG, therefore, charging current Ic to the battery 30 is fixed once the temperature is under a certain threshold.

The charging circuit 20 contains a voltage input port 21 for receiving electric current used to charge the battery 30 and a ground port 25 for connecting the charging circuit 20 to ground. A current output port 22 is used for outputting the charging current Ic to the positive voltage terminal 32 of the battery 30. A programming port 24 is connected to a resistor R. The resistor R is fixed on the circuit board on which the charging circuit 20 is fixed and cannot be changed thereafter. Since the battery charging system 10 uses the resistor R with a fixed resistance, the charging current Ic provided by the charging circuit 20 to the battery 30 is also fixed.

The controller 50 contains the GPIO port 51 connected to an enable port 23 of the charging circuit 20 for enabling or disabling the charging circuit 20. As the charging circuit 20 outputs the charging current Ic to the battery 30, the temperature of the battery 30 will slowly increase. The controller 50 is able to determine the temperature of the battery 30 from the digital representation of the resistance produced by the NTC thermistor 38. If the temperature is above a threshold level of the battery 30, above which the battery 30 could become damaged, the controller 50 disables the charging circuit 20 by sending a disable signal to the enable port 23 of the charging circuit 20. Thus, the battery charging system 10 relies on the controller 50 to stop the charging circuit 20 from charging the battery 30 when the temperature of the battery 30 exceeds the threshold level. Unfortunately, when the controller 50 suddenly stops the charging circuit 20 from outputting the charging current Ic to the battery 30, the battery 30 may not be left with a full charge.

### SUMMARY OF THE INVENTION

It is therefore a primary objective of the claimed invention to provide a battery charging system and related method for dynamically adjusting a charging current according to a temperature of the battery in order to solve the above-mentioned problems.

According an exemplary embodiment of the claimed invention, a battery charging system includes a battery having an input port for receiving a charging current for charging the battery, an output port, and a thermistor electrically connected to the output port. For battery temperatures above a threshold temperature, a resistance produced by the thermistor increases as the battery temperature increases. The battery charging system also includes a charging circuit, including an input connector electrically connected to the output port of the battery and a resistance measuring circuit electrically connected to the input connector for measuring the resistance produced by the thermistor of the battery. A current generating circuit produces a charging current according to the resistance measured by the resistance measuring circuit, and as the resistance measured by the measuring circuit increases, the charging current produced by the current generating circuit decreases. An output connector of the charging circuit is electrically connected to the input port of the battery for providing the charging current to the battery.

According another exemplary embodiment of the claimed invention, a method for safely charging a battery includes providing a battery comprising a thermistor for indicating the temperature of the battery in terms of a resistance, where for battery temperatures above a threshold temperature, the resistance produced by the thermistor increases as the battery temperature increases. The method also includes measuring the resistance produced by the thermistor of the battery, producing a charging current according to the measured resistance, where as the measured resistance increases, the produced charging current decreases, and providing the charging current to the battery for charging the battery.

According another exemplary embodiment of the claimed invention, a rechargeable battery is provided. The battery contains an input port for receiving a charging current for charging the battery, an output port, and a negative temperature coefficient (NTC) thermistor connected in series with a positive temperature coefficient (PTC) thermistor, the series combination of the NTC thermistor and the PTC thermistor being electrically connected to the output port for indicating the temperature of the battery in terms of a resistance.

It is an advantage of the claimed invention that as the temperature of the battery increases, the current provided by the current generating circuit of the charging circuit automatically decreases. Thus, even when the temperature of the battery is high, the charging circuit can still provide a small charging current to the battery for fully charging the battery. As the battery cools off again and is still not fully charged, the charging current can gradually increase the charging current for more quickly finishing the battery charging process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a battery charging system according to the prior art.

FIG. 2 is a diagram of a battery charging system according to the present invention.

FIG. 3 is a detailed diagram of the charging circuit according to the present invention.

FIG. 4 is a graph illustrating the characteristics of NTC and PTC thermistors.

### DETAILED DESCRIPTION

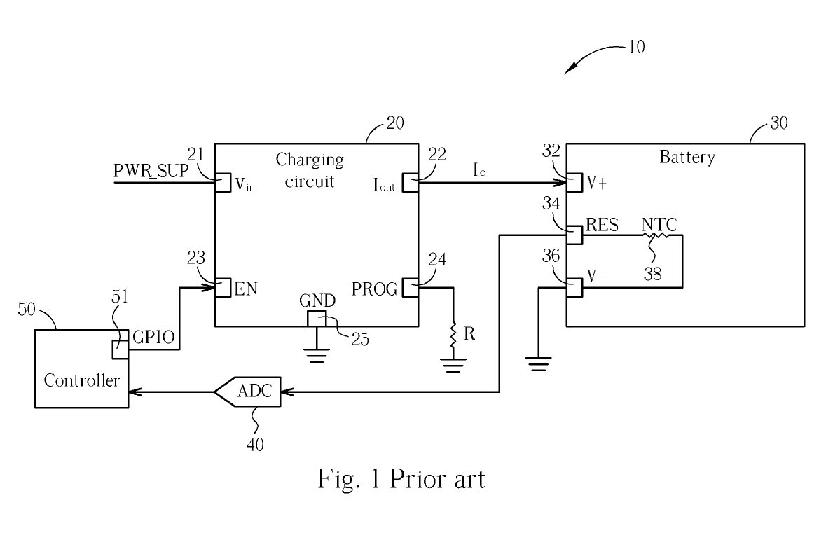

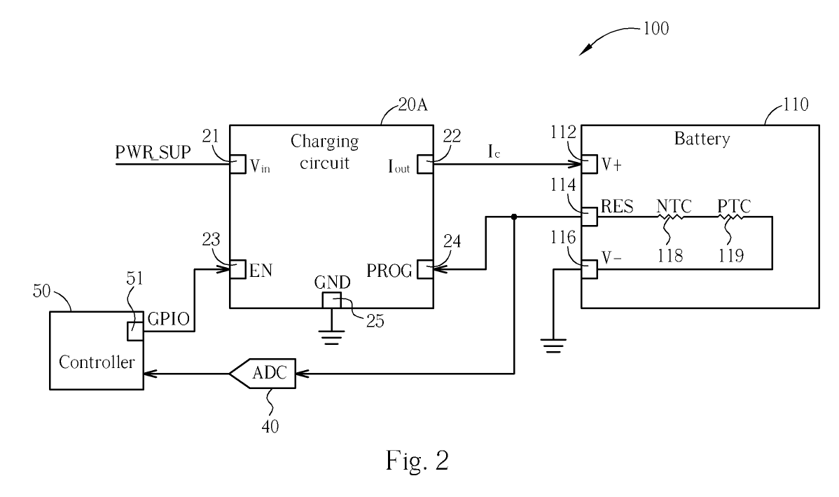

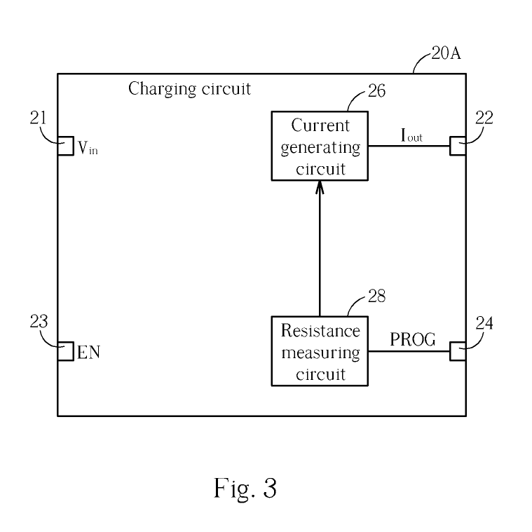

Please refer to FIG. 2 and FIG. 3. FIG. 2 is a diagram of a battery charging system 100 according to the present invention. The battery charging system 100 contains a battery 110 charged by a charging circuit 20A. FIG. 3 is a detailed diagram of the charging circuit 20A according to the present invention. The charging circuit 20A is an improved version of the charging circuit 20 shown in FIG. 1. The battery 110 can be a lithium battery or other types of rechargeable batteries. Furthermore, the battery 110 of the present invention can be a mobile phone battery or can be used to power a variety of other portable electronic devices.

In the charging circuit 20A, the value of a resistance connected to the programming port 24 determines the magnitude of the charging current Ic output by the charging circuit 20A, and the higher the resistance value is, the lower the charging current Ic will be. To accomplish this, the charging circuit 20A contains a resistance measuring circuit 28 and a current generating circuit 26. The resistance measuring circuit 28 is connected to the programming port 24, and measures the resistance received from an outputting port 114 of the battery 110. The resistance measuring circuit 28 then passes this information on to the current generating circuit 26, which outputs the charging current Ic based on the value of the measured resistance.

Unlike the prior art battery 30 shown in FIG. 1, the battery 110 contains a negative temperature coefficient (NTC) thermistor 118 connected in series with a positive temperature coefficient (PTC) thermistor 119 between the resistance outputting port 114 and a negative voltage terminal 116 of the battery 110. The battery 110 also contains a positive voltage terminal 112 for receiving the charging current Ic from the charging circuit 20A, whereas a negative voltage terminal 116 is connected to ground.

Another major difference between the battery charging system 10 shown in FIG. 1 and the battery charging system 100 is the direct connection of the resistance outputting port 114 of the battery 110 to the programming port 24 of the charging circuit 20A. Thus, a variable resistance is connected to the resistance measuring circuit 28 of the charging circuit 20A. The resistance outputting port 114 is also connected to the controller 50 via the analog-to-digital converter 40 for allowing the controller 50 to know the temperature of the battery 110.

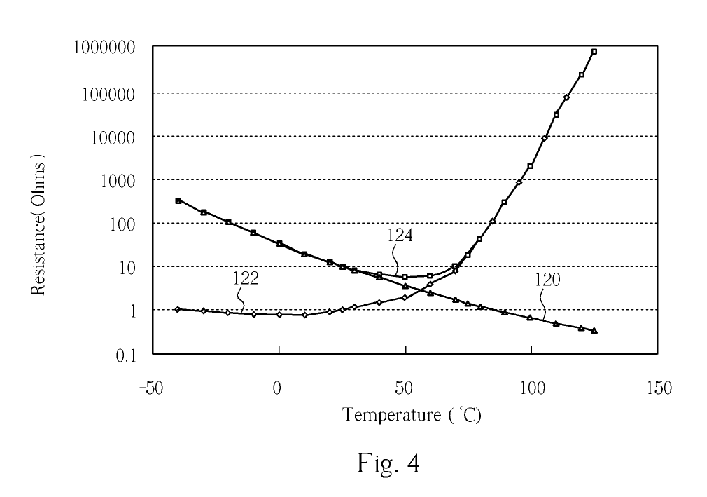

Please refer to FIG. 2 and FIG. 4. FIG. 4 is a graph illustrating the characteristics of NTC and PTC thermistors. Resistance versus temperature plots are depicted for the NTC thermistor 118, the PTC thermistor 119, and the series combination of the NTC thermistor 118 and the PTC thermistor 119. Plot 120 represents the resistance-temperature characteristics of the NTC thermistor 118, and shows that as the temperature of the NTC thermistor 118 increases, the resistance output by the NTC thermistor 118 decreases. On the other hand, plot 122 represents the resistance-temperature characteristics of the PTC thermistor 119, and shows that as the temperature of the PTC thermistor 119 increases, the resistance output by the PTC thermistor 119 increases. Plot 124 represents the resistance-temperature characteristics of the series combination of the NTC thermistor 118 and the PTC thermistor 119. The combined series resistance will simply be the sum of the resistances of the NTC thermistor 118 and the PTC thermistor 119. The plot 124 experiences a turning point around a threshold temperature of approximately 50° C. For temperatures below the threshold temperature, as the temperature of the thermistors increases, the resistance output by the series combination of the thermistors decreases. For temperatures above the threshold temperature, as the temperature of the thermistors increases, the resistance output by the series combination of the thermistors increases. Thus, plot 124 closely follows the plot 120 for temperatures below the threshold temperature and closely follows the plot 122 for temperatures above the threshold temperature.

Please keep in mind that the numbers for the resistances and temperatures shown in FIG. 4 are used solely as an example, and can be changed according to the characteristics of the battery 110 and the charging circuit 20A. In this example, the battery 110 should be charged at a temperature of approximately 0° C. to 45° C., and should not be charged at temperatures much greater than 50° C. Since the resistance output by the series combination of the NTC thermistor 118 and the PTC thermistor 119 rapidly increases for temperatures above the threshold temperature, the charging current Ic generated by the current generating circuit 26 of the charging circuit 20A will be reduced accordingly.

The GPIO port 51 of the controller 50 can be used for sending enable or disable signals to the enable port 23 of the charging circuit 20A for starting and stopping the charging process according to the charge level of the battery 110. However, in normal situations the controller 50 of the present invention battery charging system 100 does not need to control the charging process according to the temperature of the battery 110. The reason for this is due to the resistance characteristics of the series combination of the NTC thermistor 118 and the PTC thermistor 119. As the temperature of the battery 110 goes over the threshold level at which point the resistance of the thermistors starts to increase, the resistance increases very rapidly. This has the function of quickly lowering the charging current Ic supplied by the charging circuit 20A to the battery 110 for charging the battery 110. Supplying the reduced charging current Ic enables the battery charging system 100 to still continue charging the battery 110 without running the risk of the battery temperature further increasing. Thus, the series combination of the NTC thermistor 118 and the PTC thermistor 119 provides a simple and effective control mechanism for providing a proper charging current Ic based on the temperature of the battery 110. However, if the temperature rises too quickly and creates an abnormal situation, the controller 50 can still send a disable signal to the charging circuit 20A for quickly cutting off the charging current Ic.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A battery charging system, comprising:
a battery, comprising:
an input port for receiving a charging current for charging the battery;
an output port; and
a thermistor electrically, connected to the output port, wherein for battery temperatures above a threshold temperature, a resistance produced by the thermistor increases as the battery temperature increases; and
a charging circuit, comprising:
an input connector electrically connected to the output port of the battery;
a resistance measuring circuit electrically connected to the input connector for measuring the resistance produced by the thermistor of the battery;
a current generating circuit for producing a charging current according to the resistance measured by the resistance measuring circuit, wherein as the resistance measured by the measuring circuit increases, the charging current produced by the current generating circuit decreases; and
an output connector electrically connected to the input port of the battery for providing the charging current to the battery.

2. The system of claim 1, wherein the thermistor comprises a negative temperature coefficient (NTC) thermistor connected in series with a positive temperature coefficient (PTC) thermistor.

3. The system of claim 2, wherein for battery temperatures below the threshold temperature, the resistance produced by the thermistor decreases as the battery temperature increases, and for battery temperatures above the threshold temperature, the resistance produced by the thermistor increases as the battery temperature increases.

4. The system of claim 1, wherein the battery is a lithium battery.

5. The system of claim 1, wherein the threshold temperature is approximately 50° C.

6. A method for safely charging a battery, the method comprising:
providing a battery comprising a thermistor for indicating the temperature of the battery in terms of a resistance, wherein for battery temperatures above a threshold temperature, the resistance produced by the thermistor increases as the battery temperature increases;
measuring the resistance produced by the thermistor of the battery;
producing a charging current according to the measured resistance, wherein as the measured resistance increases, the produced charging current decreases; and
providing the charging current to the battery for charging the battery.

7. The method of claim 6 further comprising: setting the thermistor with a negative temperature coefficient (NTC) thermistor and a positive temperature coefficient (PTC) thermistor serially.

8. The method of claim 7, wherein for battery temperatures below the threshold temperature, the resistance produced by the thermistor decreases as the battery temperature increases, and for battery temperatures above the threshold temperature, the resistance produced by the thermistor increases as the battery temperature increases.

9. The method of claim 6, wherein the threshold temperature is approximately 50° C.

10. A rechargeable battery, comprising:
an input port for receiving a charging current for charging the battery;
an output port; and
a negative temperature coefficient (NTC) thermistor connected in series with a positive temperature coefficient (PTC) thermistor, the series combination of the NTC thermistor and the PTC thermistor being electrically connected to the output port for indicating the temperature of the battery in terms of a resistance.

11. The battery of claim 10, wherein for battery temperatures below a threshold temperature, the resistance produced by the series combination of the NTC thermistor and the PTC thermistor decreases as the battery temperature increases, and for battery temperatures above the threshold temperature, the resistance produced by the series combination of the NTC thermistor and the PTC thermistor increases as the battery temperature increases.

12. The battery of claim 10, wherein the battery is a lithium battery.

13. The battery of claim 10, wherein the threshold temperature is approximately 50° C.
